(19) United States
(12) Patent Application Publication
(10) Pub. No.: US 2009/0125924 A1
(43) Pub. Date: May 14, 2009

(54) Disk Loading Apparatus

(76) Inventors: Akihiro Fukasawa, Kyoto (JP); Masanori Ootomo, Tokyo (JP)

Correspondence Address: BIRCH STEWART KOLASCH & BIRCH, PO BOX 747, FALLS CHURCH, VA, 22040-0747, US

(21) Appl. No.: 12/083,930

(22) PCT Filed: Oct. 18, 2006
(86) PCT No.: PCT/JP2006/320705

§ 371 Date: Apr. 21, 2008

(30) Foreign Application Priority Data
Dec. 21, 2005 (JP) 2005-367378

(51) Int. Cl. G11B 17/04

(52) U.S. Cl. 720/613; G9B/17.013

(57) ABSTRACT

A disk loading apparatus includes a tray (2) on which a disk is placed, a main chassis (1) into which the tray (2) is inserted and from which the tray (2) is ejected, a first horizontal guide (1a) provided on the main chassis (1) to guide the tray (2) in an insertion/ejection direction, and a to-be-guided portion (2b) provided on the tray (2). A sliding portion (2d) provided on the to-be-guided portion of the tray (2) contacts an inclined surface of a contact portion (10a) formed on (or provided adjacent to) the first horizontal guide (1a), so as to restrict the displacement of the tray (2) in the direction perpendicular to the insertion/ejection direction in a plane parallel to the disk surface using the weight of the tray (2).

### TECHNICAL FIELD

This invention relates to a disk loading apparatus used to carry a disk which is an information recording medium such as, for example, a CD (Compact Disk), DVD (Digital Versatile Disk) or the like.

### BACKGROUND ART

In a general disk loading apparatus, a drive gear for driving a tray in an insertion/ejection direction (a direction of insertion and ejection) is provided in a main chassis. A rack engaging the drive gear is formed integrally on the lateral side of the tray. Further, in order to guide the tray in the insertion/ejection direction, a first horizontal guide is provided in the vicinity of an end portion (on the ejection side) of the main chassis. A second horizontal guide is provided on the inner side with respect to the first horizontal guide. A to-be-guided portion (a groove portion) formed on the tray engages the first horizontal guide and the second horizontal guide.

Here, a center of gravity of the tray is located substantially at a center portion of a disk placing portion of the tray, and therefore does not coincide with a position where a driving force of the drive gear is applied to the rack. Therefore, when the tray is to be driven in the insertion/ejection direction, a force is generated, which may cause the tray to rotate about the center of gravity. This force is largely generated when the moving speed of the tray rapidly changes. In other words, a quake (a displacement) occurs in a direction perpendicular to the proceeding direction of the tray and in a plane parallel to a disk surface, immediately after the tray starts moving from the ejected position to the insertion side (immediately after the insertion of the tray is started), or immediately before the tray that has moved from the inserted position to the ejection side stops (immediately before the completion of the ejection of the tray).

The amount of displacement of the tray is the largest at the end portion on the ejection side (protruding from the main chassis), and the amount of the displacement is determined by a gap between the to-be-guided portion of the tray and the horizontal guide of the main chassis, or the like. To be more specific, it is determined according to a distance between the above described first horizontal guide and the second horizontal, guide, or a gap between the to-be-guided portion of the tray and the first and second horizontal guides. Therefore, if the distance between the first horizontal guide and the second horizontal guide can be lengthened, or if the gap between the to-be-guided portion and the first and second horizontal guides can be shortened, the amount of displacement of the tray can be restricted. However, if the former is employed, there is a disadvantage in miniaturizing the size of the disk device. If the latter is employed, an operation load due to a friction between the to-be-guided portion and the guide increases according to parts accuracy, and there is a possibility that the insertion/ejection operation of the tray may be interfered.

Therefore, a disk loading apparatus that solves such problems is proposed (see, for example, Patent Document 1). In this disk loading apparatus, the tray is guided by a first horizontal guide and a second horizontal guide (disposed on the inner side with respect to the first horizontal guide) in a first section where the tray moves from the ejected position halfway to the insertion side. Further, the tray is guided by the first horizontal guide and a third horizontal guide (disposed on the inner side with respect to the second horizontal guide) in a second section until the tray is inserted into the disk device. Further, in the second section (where the tray is guided by the first horizontal guide and the third horizontal guide), the to-be-guided portion is not guided by the second horizontal guide. With such an arrangement, the second horizontal guide and the third horizontal guide do not guide the tray at the same time, and therefore a trouble that the operation load becomes excessively large does not likely to occur, even if the gaps between the to-be-guided portion and the respective horizontal guides are set narrow.

This point will be further described in detail. Generally, gaps between the to-be-guided portion of the tray and the horizontal guides (the first, second and third horizontal guides) of the main chassis are constant, and the to-be-guided portion is guided by three horizontal guides immediately before the insertion operation of the tray is completed. Therefore, according to a positioning accuracy of the three horizontal guides and a linear accuracy of the to-be-guided portion, a friction between the to-be-guided portion and the horizontal guide increases during the insertion/ejection operation, and the operation load becomes excessively large. Therefore, in order to make the insertion/ejection operation smooth, initial gaps must be set so as to take into consideration the positioning accuracy of three horizontal guides and the linear accuracy of the to-be-guided portion. Therefore, it is difficult to set gaps so as to prevent the quake of the tray. In contrast, in the disk loading apparatus disclosed in Patent Document No. 1, the to-be-guided portion is not guided by the second horizontal guide while the to-be-guided portion of the tray is guided by the first horizontal guide and the third horizontal guides, and therefore the to-be-guided portion is consistently guided by two horizontal guides throughout the whole section of the insertion/ejection operation of the tray. Therefore, it is not necessary to take into consideration the positioning accuracy of the horizontal guides and the linear accuracy of the to-be-guided portion, so that it is possible to set narrow initial gaps between the to-be-guided portion and the first and second horizontal guides.

Patent Document No. 1: Laid-Open Patent Publication 2001-291302 (Pages 2-3, FIG. 10).

### DISCLOSURE OF THE INVENTION

### Problems to be Solved by the Invention

However, even in case of such a disk loading apparatus, it is necessary to provide gaps between the respective horizontal guides of the main chassis and the to-be-guided portion of the tray, in order to accomplish a stable insertion/ejection operation of the tray. Therefore, there is a problem that, although the quake of the tray can be enhanced to some extent, but the quake can not be resolved. Further, according to shapes and positions of the horizontal guides, a bumpy movement occurs when the guiding of the to-be-guided portion is switched from the second horizontal guide to the third horizontal guide during the insertion/ejection operation of the tray, and therefore there is a problem that the stable insertion/ejection is interfered.

The present invention is intended to solve the above described problems, and the object of the present invention is to provide a disk loading apparatus capable of restricting a displacement (a quake) of a tray that tends to occur immediately after the insertion of the tray is started or immediately before the ejection of the tray is completed, and capable of accomplishing a stable insertion/ejection operation.

### Means of Solving the Problems

The present invention provides a disk loading apparatus including a tray on which a disk is placed, a main chassis into which said tray is inserted and from which said tray is ejected, a guide member provided on said main chassis and guiding said tray in an insertion/ejection direction, a to-be-guided portion provided on said tray so as to be parallel to said insertion/ejection direction and being guided by said guide member, and a displacement restricting mechanism that restricts a displacement of said tray in a direction perpendicular to said insertion/ejection direction in a plane parallel to a disk surface, using a weight of said tray.

### Effect of the Invention

According to the disk loading apparatus of the present invention, the displacement restricting mechanism restricts the displacement of the tray in the direction perpendicular to the insertion/ejection direction in the plane parallel to the disk surface, using the weight of the tray. With this, it becomes possible to restrict the displacement of the tray that has conventionally occurred immediately after the insertion of the tray is started or immediately before the ejection of the tray is completed. As a result, it becomes possible to accomplish a stable insertion/ejection operation.

### BRIEF DESCRIPTION OF THE DRAWINGS

FIG. 1 is an exploded perspective view of a disk loading apparatus according to Embodiment 1 of the present invention.

FIG. 2 is a partial perspective view of a vicinity of a first horizontal guide of the disk loading apparatus according to Embodiment 1 of the present invention.

FIG. 3 is a perspective view of a tray of the disk loading apparatus according to Embodiment 1 of the present invention, as seen from the back side.

FIG. 4 FIG. 4(A) is a sectional view of the vicinity of the first horizontal guide of the disk loading apparatus according to Embodiment 1 of the present invention, as seen from the front. FIG. 4(B) is a sectional view of a to-be-guided portion of −X side of the tray. FIG. 4(C) is a sectional view showing another configuration example of the to-be-guided portion of the tray.

FIG. 5 is a perspective view showing a state where the tray is inserted into the disk loading apparatus according to Embodiment 1 of the present invention.

FIG. 6 is a perspective view showing a state where the tray is ejected from the disk loading apparatus according to Embodiment 1 of the present invention.

FIG. 7 is a view for illustrating a reason why a displacement of the tray occurs immediately after an insertion/ejection of the tray is started.

FIG. 8 is a view showing a static balance between reactive forces applied to on the tray in a state where the tray is inserted.

FIG. 9 is a view showing a static balance between reactive forces applied to the tray in a state where the tray is ejected.

FIG. 10 is a sectional view showing a vicinity of a second vertical guide of a disk loading apparatus according to Embodiment 2 of the present invention in a state where a tray is inserted, as seen from the front.

FIG. 11 is a sectional view showing the vicinity of the second vertical guide of the disk loading apparatus according to Embodiment 2 of the present invention in a state where the tray is ejected, as seen from the front.

FIG. 12 is a sectional view showing a vicinity of a first horizontal guide of a disk loading apparatus according to Embodiment 3 of the present invention, as seen from the front.

FIG. 13 is a sectional view showing a vicinity of a first horizontal guide of a disk loading apparatus according to Embodiment 4 of the present invention, as seen from the front.

FIG. 14 is a sectional view showing a vicinity of a first horizontal guide of a disk loading apparatus according to Embodiment 5 of the present invention, as seen from the front.

FIG. 15 is a sectional view showing a vicinity of a first horizontal guide of a disk loading apparatus according to Embodiment 6 of the present invention, as seen from the front.

FIG. 16 is a sectional view showing a vicinity of a first horizontal guide of a disk loading apparatus according to Embodiment 7 of the present invention, as seen from the front.

FIG. 17 is a sectional view showing a vicinity of a first horizontal guide of a disk loading apparatus according to Embodiment 8 of the present invention, as seen from the front.

FIG. 18 is a sectional view showing a vicinity of a first horizontal guide of a disk loading apparatus according to Embodiment 9 of the present invention, as seen from the front.

FIG. 19 is a sectional view showing a vicinity of a first horizontal guide of a disk loading apparatus according to Embodiment 10 of the present invention, as seen from the front.

FIG. 20 is a sectional view showing a vicinity of a first horizontal guide of a disk loading apparatus according to Embodiment 11 of the present invention, as seen from the front.

FIG. 21 is a sectional view showing a vicinity of a first horizontal guide of a disk loading apparatus according to Embodiment 12 of the present invention, as seen from the front.

FIG. 22 is a sectional view showing a vicinity of a first horizontal guide of a disk loading apparatus according to Embodiment 13 of the present invention, as seen from the front.

FIG. 23 is a sectional view showing a vicinity of a first horizontal guide of a disk loading apparatus according to Embodiment 14 of the present invention, as seen from the front.

FIG. 24 is a sectional view showing a vicinity of a first horizontal guide of a disk loading apparatus according to Embodiment 15 of the present invention, as seen from the front.

FIG. 25 is a sectional view showing a vicinity of a first horizontal guide of a disk loading apparatus according to Embodiment 16 of the present invention, as seen from the front.

FIG. 26 is a sectional view showing a vicinity of a second vertical guide of a disk loading apparatus according to Embodiment 17 of the present invention, as seen from the front.

FIG. 27 is a sectional view showing a vicinity of a second vertical guide of a disk loading apparatus according to Embodiment 18 of the present invention, as seen from the front.

FIG. 28 is a sectional view showing a vicinity of a second vertical guide of a disk loading apparatus according to Embodiment 19 of the present invention, as seen from the front.

### DESCRIPTION OF REFERENCE MARKS

1 . . . main chassis, 1a . . . first horizontal guide, 1b . . . second horizontal guide, 1c . . . third horizontal guide, 1d . . . first vertical guide, 1e . . . second vertical guide, 2 . . . tray, 2a . . . disk placing portion, 2b . . . to-be-guided portion, 2c . . . rack, 2d . . . first sliding portion, 2e . . . second sliding portion, 3 . . . drive gear, 4 . . . turntable, 10a . . . first contact portion, 10b . . . second contact portion.

### BEST MODE FOR CARRYING OUT THE INVENTION

### Embodiment 1

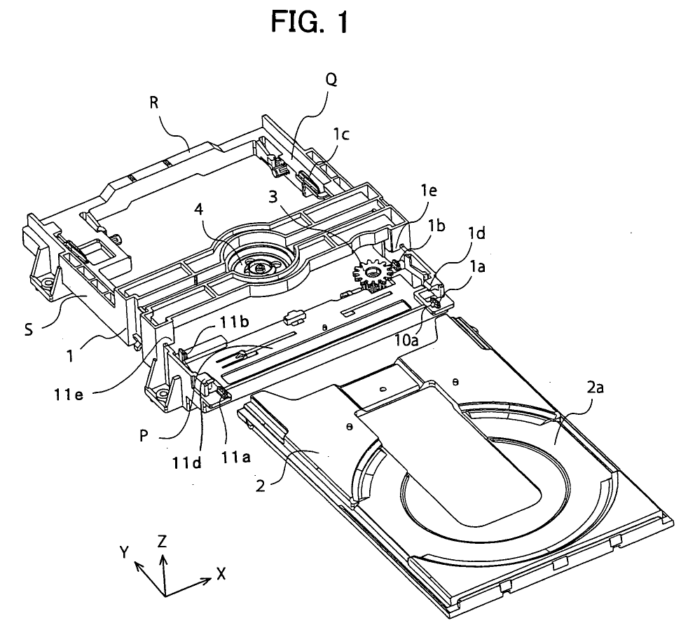

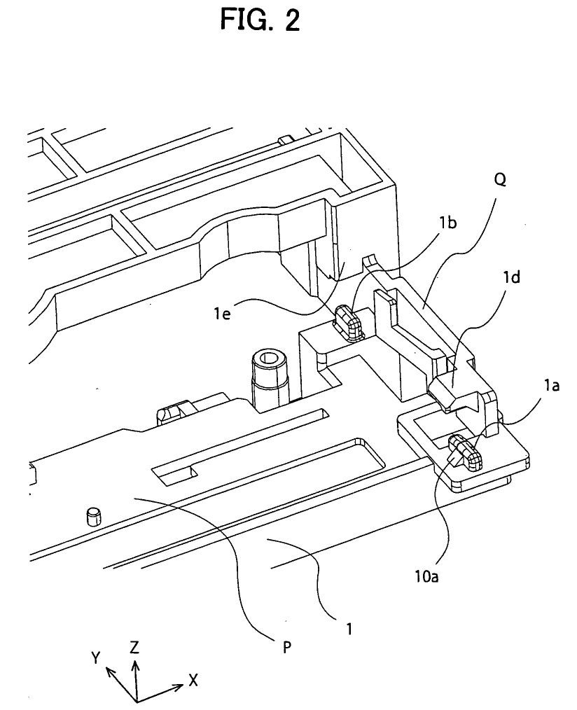

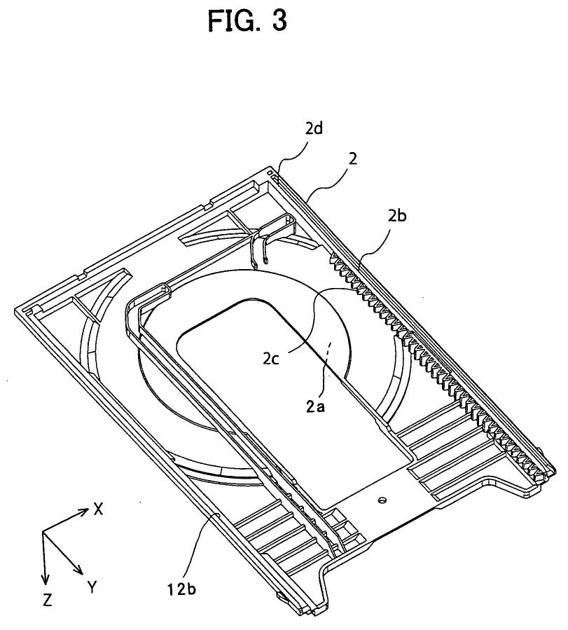

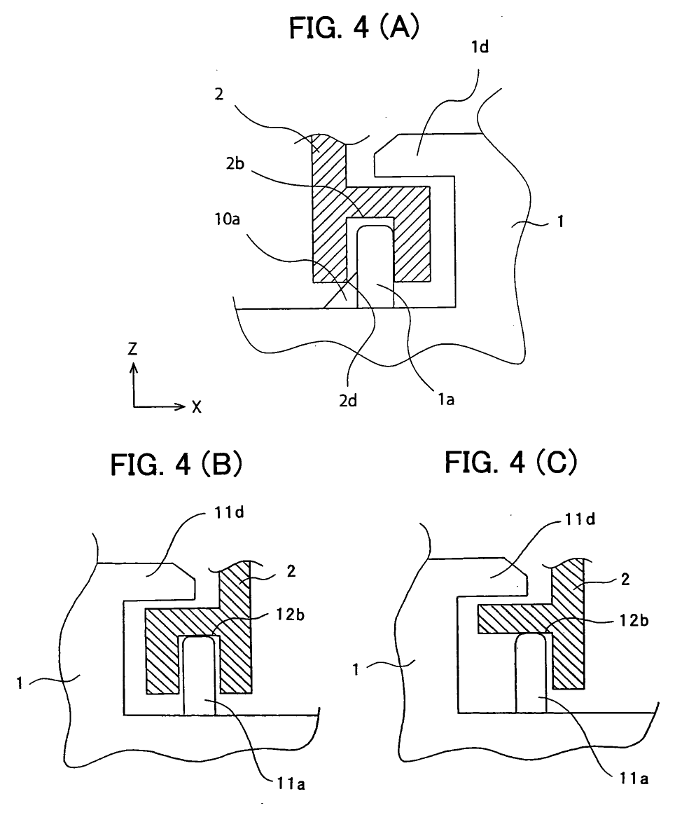

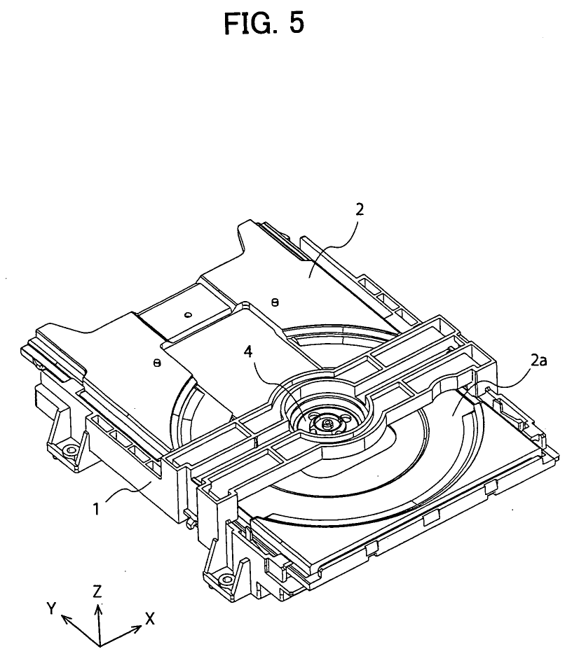

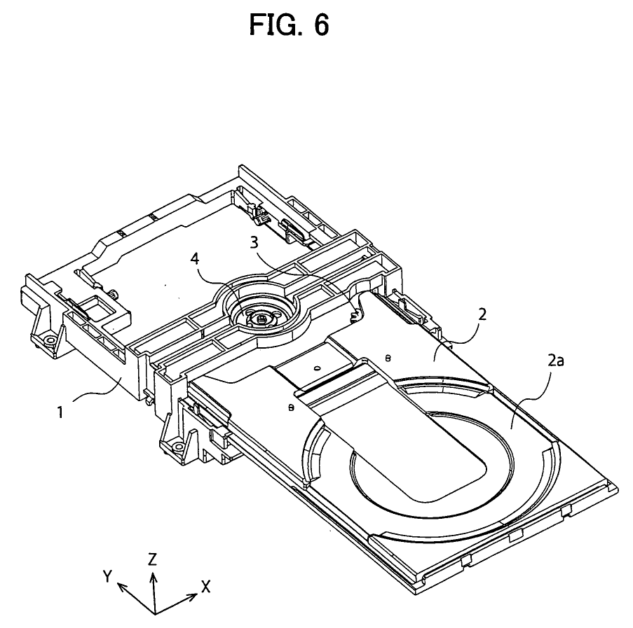

FIG. 1 is an exploded perspective view of a disk loading apparatus according to Embodiment 1 of the present invention. FIG. 2 is a partial perspective view showing a vicinity of a first horizontal guide 1a of the disk loading apparatus according to Embodiment 1. FIG. 3 is a perspective view of a tray of the disk loading apparatus according to Embodiment 1, as seen from the back side. FIG. 4(A) is a sectional view of the vicinity of the first horizontal guide 1a of the disk loading apparatus according to Embodiment 1, as seen from the front. FIG. 5 is a perspective view showing a state where the tray 2 is inserted into the disk loading apparatus according to Embodiment 1. FIG. 6 is a perspective view showing a state where the tray 2 is ejected from the disk loading apparatus according to Embodiment 1. FIG. 7 is a view for illustrating a reason why a displacement (a quake) of a tray occurs in a disk loading apparatus.

As shown in FIG. 1, the disk loading apparatus includes a main chassis 1 which constitutes a base body. The main chassis 1 includes a front piece P, a right side piece Q, a rear piece R and a left side piece S, and forms a rectangular frame-like body. A tray 2 on which a not shown optical disk is placed is provided in the main chassis 1 so that the tray 2 is able to reciprocate. Further, a turntable 4 for holding and rotating the optical disk is provided in the main chassis 1.

Hereinafter, for convenience of description, the direction of the rotation axis of the turntable 4 is referred to as Z direction. The direction from the tray 2 toward the optical disk side is referred to as +Z direction (upward), and the opposite direction is referred to as −Z direction (downward). The insertion/ejection direction of the tray 2 is referred to as Y direction. The direction in which the tray 2 is inserted into the main chassis 1 is referred to as +Y direction (rearward), and the direction in which the tray 2 is ejected form the main chassis 1 is referred to as −Y direction (frontward). The direction perpendicular to the Y direction in a plane parallel to a surface of the optical disk (a disk surface) is referred to as X direction (left-right direction). The right direction as one faces in the +Y direction is referred to as +X direction, and the opposite direction is referred to as −X direction.

A first horizontal guide 1a is provided on the right side piece Q of the main chassis 1 at an end portion in the −Y direction (an end portion on the ejection side of the tray 2). A second horizontal guide 1b is provided on the right side piece Q at an inner side with respect to the first horizontal guide 1a, and a third horizontal guide 1c is provided on the right side piece Q at an inner side with respect to the second horizontal guide 1b. The first, second and third horizontal guides 1a, 1b and 1c are linearly arranged along the Y direction so as to guide the tray 2 in the Y direction. Further, as shown in FIG. 2, a first contact portion 10a is formed integrally on a −X side of the first horizontal guide 1a, and the first contact portion 10a has an inclined surface which is inclined so that the height (dimension in the Z direction) decreases toward the −X side.

The tray 2 is used to insert the optical disk (not shown) placed thereon into the main chassis 1, or to eject the optical disk from the main chassis 1 as described above. A disk placing portion 2a (FIG. 1) on which the optical disk can be placed is formed on the surface side of the tray 2. On the back side of the tray 2, a to-be-guided portion 2b extending in the Y direction is integrally formed at the end portion of the tray 2 in the +X direction, as shown in FIG. 3. The to-be-guided portion 2b is a groove portion opened toward the −Z side and having a substantially rectangular cross section, and is slidably guided by the horizontal guides 1a, 1b and 1c. Further, a rack portion 2c extending in the Y direction is integrally formed on the −X side of the to-be-guided portion 2b. The rack portion 2c engages a drive gear 3 (described later), and is applied with a force for driving the tray 2 in the Y direction.

Further, in a state where the tray 2 is inserted, the to-be-guided portion 2b of the tray 2 is guided and supported by all of the first horizontal guide 1a, the second horizontal guide 1b and the third horizontal guide 1c of the main chassis 1. In contrast, in a state where the tray 2 is ejected, the to-be-guided portion 2b of the tray 2 is guided and supported by only the first horizontal guide 1a and the second horizontal guide 1b.

As shown in FIG. 1, a first vertical guide 1d is provided on the +Z side (upward in figure) of the first horizontal guide 1a so as to face the first horizontal guide 1a. Further, a second vertical guide 1e is provided on the +Z side of the second horizontal guide 1b so as to face the second horizontal guide 1b. The first vertical guide 1d and the second vertical guide 1e restrict the movement of the tray 2 in the +Z direction so that the to-be-guided portion 2b of the tray 2 is not dropped out of the horizontal guides 1a, 1b and 1c.

As shown in FIG. 4(A), the to-be-guided portion 2b of the tray 2 includes a first sliding portion 2d that contacts the inclined surface of the first contact portion 10a of the main chassis 1. The first sliding portion 2d is a ridge extending in the Y direction which is an edge of a groove constituting the to-be-guided portion 2b. The first sliding portion 2d consistently contacts the inclined surface of the first contact portion 10a of the main chassis 1 when the tray 2 is in any position of the operating range. The weight of the tray 2 is applied to the first contact portion 10a, and the tray 2 is urged in the −X direction by a force component of a reactive force from the first contact portion 10a. With this, the to-be-guided portion 2b of the tray 2 is guided so as to form no gap between the to-be-guided portion 2b and the first horizontal guide 1a. As a result, the displacement of the tray 2 in the X direction is restricted.

In contrast, as shown in FIG. 1, the left end piece S of the main chassis 1 is provided with horizontal guides 11a, 11b and 11c (the horizontal guide 11c is not shown) which are the same as the horizontal guides 1a, 1b and 1c of the right side piece Q. The left side piece S is also provided with vertical guides 11d and 11e which are the same as the vertical guides 1d and 1e of the right side piece Q. As shown in FIG. 4(B), in the vicinity of the end portion of the −X side of the tray 2, a to-be-guided portion 12b is formed, which is a groove portion of a substantially rectangular shape opened toward the −Z side and slidably engages the horizontal guides 11a, 11b and 11c. The to-be-guided portion 12b is not necessarily a groove portion, but only needs to be configured so that the lower surface (a surface of −Z side) thereof contacts the horizontal guides 11a, 11b and 11c as shown in FIG. 4(C).

As shown in FIG. 1, a drive gear 3 is provided in the main chassis 1 and in the vicinity of the second horizontal guide 1b. The drive gear 3 engages the rack 2c of the tray 2 to thereby drive the tray 2 in the insertion/ejection direction. The above described turntable 4 is disposed on substantially the center portion of the main chassis 1 and underside of the movable range of the tray 2. When the tray 2 on which the optical disk is placed is inserted into the main chassis 1, a turntable 4 moves upward by a not shown turntable driving mechanism to hold the optical disk, and further moves upward to a height where the optical disk does not interfere with the disk placing portion 2a when the optical disk rotates.

The ejection of the optical disk is performed by the movement of the tray 2 from the inserted position (FIG. 5) to the ejected position (FIG. 6). In other words, the turntable 4 is first moved downward by the turntable driving mechanism to a height where the turntable 4 does not interfere with the tray 2. Then, the drive gear 3 is driven by a motor (not shown) to rotate in a forward direction. The rotation of the drive gear 3 is converted into a linear movement by the rack 2c of the tray 2, and the tray 2 moves in the −Y direction (the ejection direction) in such a manner that the to-be-engaged portion 2b of the tray 2 is guided by the horizontal guides 1a, 1b and 1c of the main chassis 1. When the tray 2 is ejected to a predetermined ejected position (a position where an ejection is completed), it is detected by an ejected position detecting means (not shown), and the rotation of the motor is stopped. In this state, the disk placing portion 2a of the tray 2 protrudes completely out of the main chassis 1, and the setting or replacement of the optical disk is enabled.

The insertion of the optical disk is performed by the movement of the tray 2 from the ejected position (FIG. 6) to the inserted position (FIG. 5). In other words, when the drive gear 3 is driven by the motor to rotate in a reverse direction, the rotation of the drive gear 3 is converted into the linear movement by the rack 2c of the tray 2, and the tray 2 moves in the +Y direction (the insertion direction) in such a manner that the to-be-guided portion 2b of the tray 2 is guided by horizontal guides 1a, 1b and 1c of the main chassis. When the tray 2 is inserted into a predetermined inserted position, it is detected by an inserted position detecting means (not shown), and the rotation of the motor is stopped. Thereafter, the turntable 4 moves upward by the turntable driving mechanism to hold the optical disk, and further moves upward to a position where the optical disk does not interfere with the disk placing portion 2b when the optical disk rotates. With the above described operation, the recording or reproducing of the information using the optical disk can be enabled.

Here, the behavior of the tray 2 during the insertion/ejection operation will be described. Although the center of gravity of the tray 2 is in the vicinity of the disk placing portion 2a, the driving force of the drive gear 3 is applied to the rack 2c provided on the side of the tray 2. In other words, the position where the drive force is applied and the center of gravity of the tray 2 do not exist on the same linear line in the Y direction. Therefore, when the tray 2 is inserted or ejected, a force is generated, which may cause a rotational displacement of the tray 2 about a position of the center of gravity. This force depends on the change in speed of the tray 2, and becomes larger as the change in speed becomes larger. Generally, the tray 2 moves at substantially constant speed in the disk loading apparatus, and the speed rapidly changes at positions where the insertion operation of the tray 2 is started and is completed, and at positions where the ejection operation of the tray 2 is started and is completed. The force that may cause the rotational displacement of the tray 2 is at its maximum in these positions.

When the tray 2 is in the inserted position, the to-be-guided portion 2b of the tray 2 is guided by three horizontal guides 1a, 1b and 1c of the main chassis 1, and therefore the rotational displacement about the Z axis is restricted by the contact of the to-be-guided portion 2b and there horizontal guides 1a, 1b and 1c. In contrast, when the tray 2 is in the ejected position, the to-be-guided portion 2b of the tray 2 is guided by only the first horizontal guide and the second horizontal guide 1b. Since the distance between the first horizontal guide 1a and the second horizontal guide 1b is short, the rotational displacement of the tray 2 may easily occur. Therefore, with respect to the force that may cause the rotational displacement of the tray 2 about the position of the center of gravity, the end (of the ejection side) of the tray 2 is most likely to quake in the left-right direction (X direction) immediately after the movement of the tray 2 from the ejected position to the inserted position is started, and immediately before the movement of the tray 2 to the ejected position is stopped.

Moreover, the behavior of the tray 2 when the insertion operation is started will be described in detail with reference to FIG. 7. FIG. 7 shows a state where the tray 2 is placed on a flat plate. In FIG. 7, the position of the center of gravity of the tray 2 is indicated as a point J, and the position on the tray 2 where the driving force of the drive gear 3 is applied is indicated as a point D. It is assumed that a guide that guides the tray 2 is not provided on the flat plate, and that only a friction force due to the weight of the tray 2 is generated between the flat plate and the tray 2. In this state, when the point D is forcibly displaced in the direction shown by an arrow M (+Y direction) along a baseline L without restricting a freedom in rotation about the Z axis at the point D, the tray 2 moves gradually from the position shown by a solid line to a position shown by a dashed line. In other words, the tray 2 rotates about the point D (i.e., moves in the direction shown by an arrow N) until the position of the center of gravity J is aligned with an extension line of the baseline J, and thereafter the point D and the point J move along the baseline L in the direction shown by the arrow M. Further, when the point D is forcibly moved in the opposite direction, the point D also moves in the opposite direction.

This operation is substantially the same as the operation of the disk loading apparatus where the first horizontal guide 1a is not provided on the main chassis 1. Therefore, in the case where the first horizontal guide 1a is provided on the main chassis 1 to guide the to-be-guided portion 2b of the tray 2 in the Y direction, the tray 2 does not rotate until the position of the center of gravity J and the position of the exertion of the driving force D are aligned on the same line in the Y direction. However, if there is a gap between the first horizontal guide 1a and the to-be-guided portion 2b in the X direction, the end of the tray 2 on the ejection side is displaced to the right in figure (+X direction) within the range of the gap.

For the above reason, in order to prevent the displacement of the tray 2 in the X direction that occurs immediately after the tray 2 starts moving from the ejected toward the inserted position, or immediately before the ejection of the tray 2 is completed, it is understood that it is necessary to eliminate the gap between the first horizontal guide 1a of the main chassis 1 and the to-be-guided portion 2b of the tray 2 in the X direction.

In Embodiment 1 of the present invention, as shown in FIG. 4(A), the first sliding portion 2d which is a ridge extending in the Y direction (the insertion/ejection direction of the tray 2) consistently contacts the first contact portion 10a of the main chassis 1 in the movable range of the tray 2, and the tray 2 is urged in the −X direction by the force component of the reactive force of the weight of the tray 2 from the first contact portion 10a. Therefore, the to-be-guided portion 2b of the tray 2 is guided so as to form no gap between the to-be-guided portion 2b and the first horizontal guide 1a in the X direction. As a result, it becomes possible to prevent the displacement of the tray 2 in the X direction even immediately after the tray 2 starts moving from the ejected position toward the inserted position, or immediately before the ejection of the tray 2 is completed, and to accomplish the stable insertion/ejection operation.

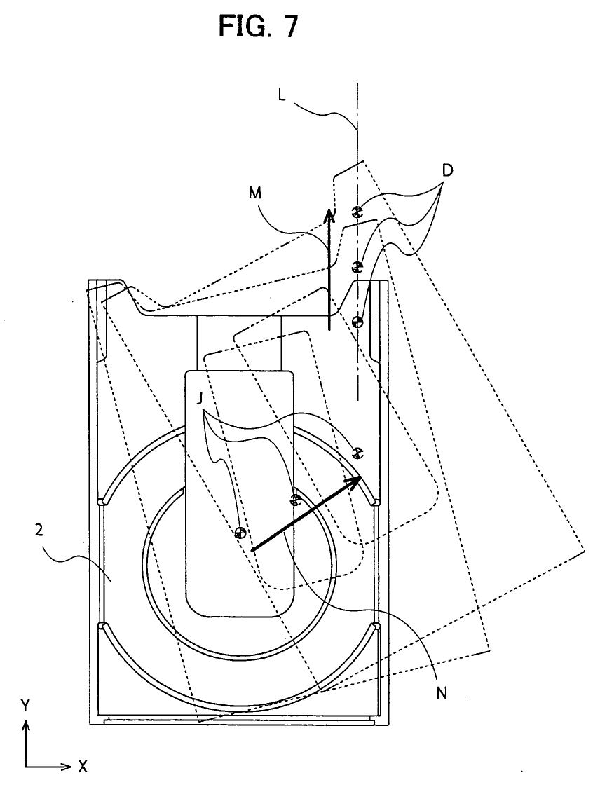

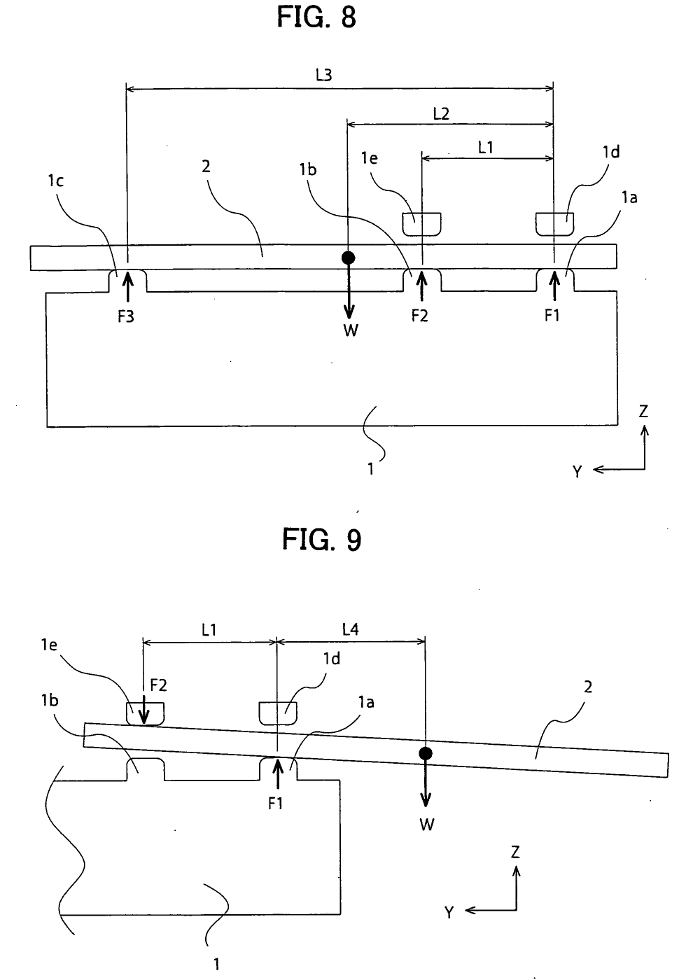

Next, the reactive force from the first contact portion 10a used as an urging force that urges the tray 2 in the X direction will be described. A magnitude of the reactive force from the first contact portion 10a differs between when the tray 2 is in the inserted position and when the tray 2 is in the ejected position. FIG. 8 is a view showing a static balance between forces applied to the tray 2 when the tray 2 is in the inserted position (a position where the insertion is completed). In FIG. 8, when the weight W of the tray 2 is applied to the position of the center of gravity, the tray 2 is applied with forces F1, F2 and F3 (each +Z direction) from the horizontal guides 1a, 1b and 1c. The distance between the first horizontal guide 1a and the second horizontal guide 1b is represented by L1, the distance between the first horizontal guide 1a and the position of the center of gravity of the tray 2 is represented by L2, and the distance between the first horizontal guide 1a and the third horizontal guide 1c is represented by L3. Based on the static balance, the reactive force F1 applied to the tray 2 by the first horizontal guide 1a is expressed as the following equation (1).

F1=(1−2·L2/(L1+L3))·W (1)

FIG. 9 is a view showing a static balance of forces applied to the tray 2 when the tray 2 is in the ejected position (a position where the ejection is completed). In FIG. 9, when the weight W of the tray 2 is applied to the position of the center of gravity, the tray 2 is applied with reactive forces F1 and F2 from the first horizontal guide 1a and the second vertical guide 1e. The reactive force F1 is in the +Z direction, but the reactive force F2 is in the −Z direction. The distance between the first horizontal guide 1a and the position of the center of gravity of the tray 2 (in the ejected position) is represented by L4. Based on the static balance, the reactive force F1 is expressed as the following equation (2).

F2=(1+L4/L1)·W (2)

Next, the reactive forces F1 when the tray 2 is in the inserted position and when the tray 2 is in the ejected position are determined by assigning representative design values as: L1=40 mm, L2=82 mm, L3=162 mm, L4=60 mm and W=30 g. When the tray 2 is in the inserted position, F1=5.7 g is obtained from the equation (1). When the tray 2 is in the ejected position, F1=75.0 g is obtained from the equation (1). Although the actual weight of the tray 2 is approximately 60 g, 30 g (half the weight of the tray 2) is used as the value of the above described W, since the weight of the tray 2 is also applied to the horizontal guides 11a, 11b and 11c provided on the left side piece S, as well as the horizontal guides 1a, 1b and 1c provided on the right side piece Q. In the actual design, for example, in the case where the disk loading apparatus is installed in a computer or the like, a storage space is standardized, and therefore the size of the main chassis 1 is primarily determined based on the storage space. Therefore, the freedom of design for positions of the horizontal guides 1a, 1b and 1c and the vertical guides 1d and 1e on the main chassis 1 is small. Further, the size of the tray 2 is also limited, and in many cases, plastic is used as a material of the tray 2. Accordingly, in any practically-used disk loading apparatus, the reactive force from the first horizontal guide 1a is close to the above described value.

As described above, it is understood that the reactive force F1 applied to the tray 2 by the first horizontal guide 1a differs between when the tray 2 is in the inserted position and when the tray 2 is in the ejected position, and that the reactive force F1 continuously decreases from 75.0 g to 5.7 g according to the insertion operation of the tray 2.

In Embodiment 1 of the present invention, the to-be-guided portion 2b of the tray 2 is urged in the −X direction against the first horizontal guide 1a using the force component of the reactive force applied to the tray 2 by the first contact portion 10a, and therefore the urging force increases as the reactive force from the first contact portion 1a becomes larger. That is, the urging force is at its maximum when the tray 2 is in the ejected position (the position where the ejection is completed). Therefore, a state where the displacement of the tray 2 in the left-right direction (the X direction) is the hardest to occur can be accomplished at the ejected position where the displacement of the end portion of the ejection side of the tray 2 (in the left-right direction) has been most likely to occur.

Further, in Embodiment 1 of the present invention, the reactive force F1 applied to the tray 2 by the first horizontal guide 1a continuously decreases from 75.0 g to 5.7 g according to the insertion operation of the tray 2. According to this, a force with which the to-be-guided portion 2b of the tray 2 is urged against the first horizontal guide 1a in the −X direction (FIG. 4(A)) also decreases. Therefore, the abrasion when the insertion/ejection operation of the tray 2 is repeated can be smaller, compared with a case where a resilient force of some resilient member is used to urge the to-be-guided portion 2b of the tray 2 against the first horizontal guide 1a in the X direction. With this, it becomes possible to keep a stable insertion/ejection operation of the tray 2 for a long time period.

### Embodiment 2

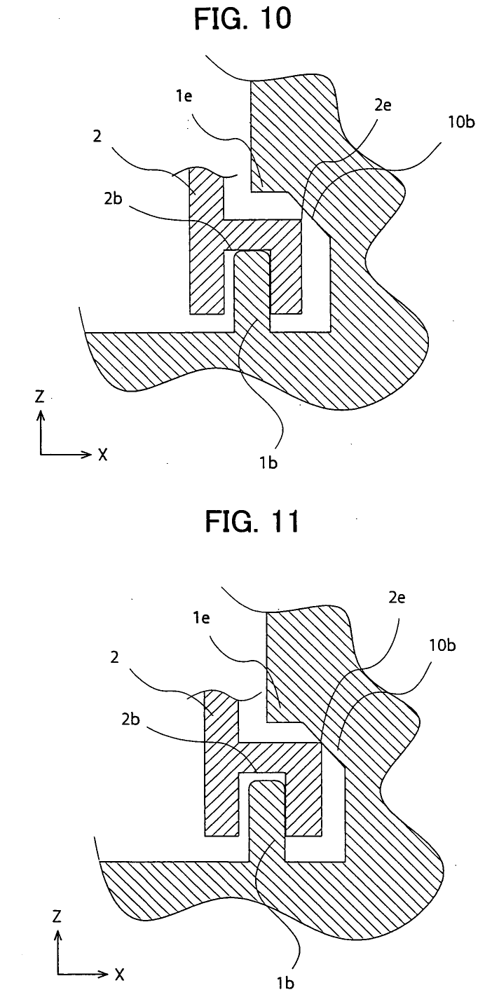

FIGS. 10 and 11 are sectional views showing a vicinity of a second vertical guide 1e of a disk loading apparatus according to Embodiment 2 of the present invention, as seen from the front. FIG. 10 shows a state where the tray 2 is inserted, and FIG. 11 shows a state where the tray 2 is ejected. In Embodiment 1, the configuration for eliminating the gap between the first horizontal guide 1a and the to-be-guided portion 2b has been described. In Embodiment 2, the configuration for further eliminating a gap between the second horizontal guide 1b and the to-be-guided portion 2b will be described. The displacement of the tray 2 in the X direction (having been described with reference to FIG. 7) can be prevented by the configuration of Embodiment 1 to a level where the displacement can not be recognized with naked eyes. However, it becomes possible to accomplish a further stable insertion/ejection operation by eliminating a gap between the second horizontal guide 1b and the to-be-guided portion 2b.

In Embodiment 2, a ridge of the upper end (an end portion on the +Z side) on the +X side of the to-be-guided portion 2b of the tray 2 constitutes a second sliding portion 2e. Further, a second contact portion 10b is integrally formed on the second vertical guide 1e of the main chassis 1 so as to contact the second sliding portion 2e of the to-be-guided portion 2b, and the second contact portion 10b has an inclined surface which is inclined so that the height decreases toward the +X side. As shown in FIGS. 10 and 11, the second sliding portion 2e of the tray 2 and the second contact portion 10b of the main chassis 1 do not contact each other throughout the whole region of the movable range of the tray 2, but contact each other only at a section from the halfway (from the inserted position to the ejected position) to the ejected position. In other words, the second sliding portion 2e and the second contact portion 10b do not contact each other when the tray 2 is in the inserted position (FIG. 10), but contact each other when the tray 2 is in the ejected position (FIG. 11).

In Embodiment 2, the to-be-guided portion 2b of the tray 2 is urged in the −X direction by the force component of the reactive force from the second contact portion 10b in the section from the halfway of the movable range to the ejected position, and is guided so as to form no gap in the X direction between the to-be-guided portion 2b and the second horizontal guide 1b. Since the to-be-guided portion 2b of the tray 2 is guided at two positions of the first horizontal guide 1a and the second horizontal guide lb so as to form no gap in the X direction, it becomes possible to surely prevent the displacement of the tray 2 in the X direction that has conventionally occurred when the tray 2 is in the ejected position.

### Embodiment 3

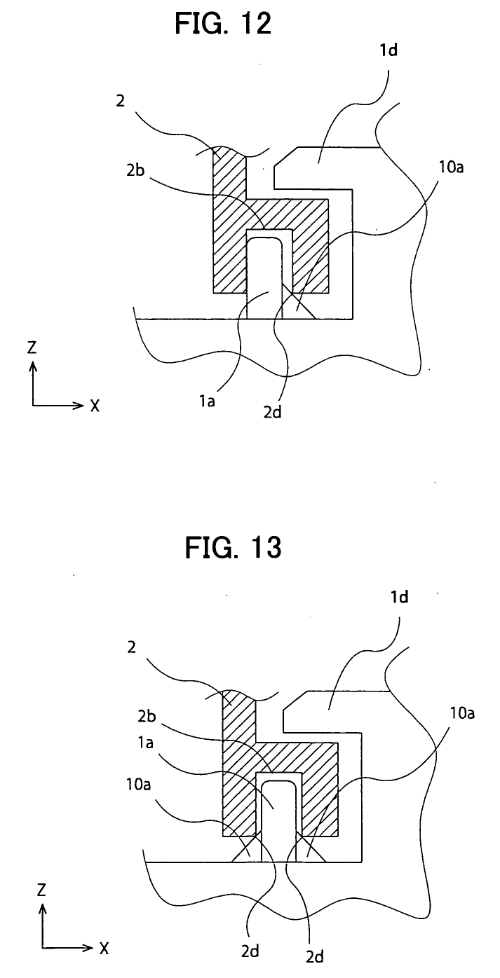

FIG. 12 is a sectional view showing a vicinity of a first horizontal guide 1a of a disk loading apparatus according to Embodiment 3 of the present invention. This Embodiment 3 is different from Embodiment 1 (FIG. 4(A)) in that the first contact portion 10a is formed on the +X side of the first horizontal guide 1a.

In the above described Embodiment 1 (FIG. 4(A)), the first contact portion 10a is formed on the −X side of the first horizontal guide 1a. In this Embodiment 3, the first contact portion 10a is formed integrally on the +X side of the first horizontal guide 1a. The inclined surface of the first contact portion 10a is inclined so that the height decreases toward the +X side, with is symmetrical with respect to the Embodiment 1. The first sliding portion 2d of the to-be-guided portion 2b of the tray 2 is constituted by an edge (a ridge) on the +X side of the groove portion the to-be-guided portion 2b. The other configuration is the same as that of Embodiment 1.

In this Embodiment 3, although the direction in which the to-be-guided portion 2b of the tray 2 is urged by the first horizontal guide 1a is different from that in Embodiment 1, it becomes possible to eliminate the gap between the to-be-guided portion 2b and the first horizontal guide 1a in the X direction to thereby prevent the displacement of the tray 2, and to accomplish a stable insertion/ejection operation.

### Embodiment 4

FIG. 13 is a sectional view showing a vicinity of a first horizontal guide 1a of a disk loading apparatus according to Embodiment 4 of the present invention, as seen from the front. In this Embodiment 4, configurations of Embodiment 1 (FIG. 4(A)) and Embodiment 3 (FIG. 12) are combined.

In other words, in this Embodiment 4, two first contact portions 10a are integrally formed on both sides of the first horizontal guide 1a, and the first contact portions 10a have inclined surfaces inclined symmetrically with respect to each other. Further, the to-be-guided portion 2b of the tray 2 has two first sliding portions 2d constituted by ridges (edges) on both sides in X direction of the groove portion thereof, and the first sliding portions 2d respectively contact the first contact portions 10a. The other configuration is the same as Embodiment 1.

In this Embodiment 4, two sliding portions 2d contact the first contact portions 10a on both sides of the first horizontal guide 1a, to thereby restrict the movement of the tray 2 in the X direction. As a result, it becomes possible to prevent the displacement of the tray 2, and to accomplish a stable insertion/ejection operation.

### Embodiment 5

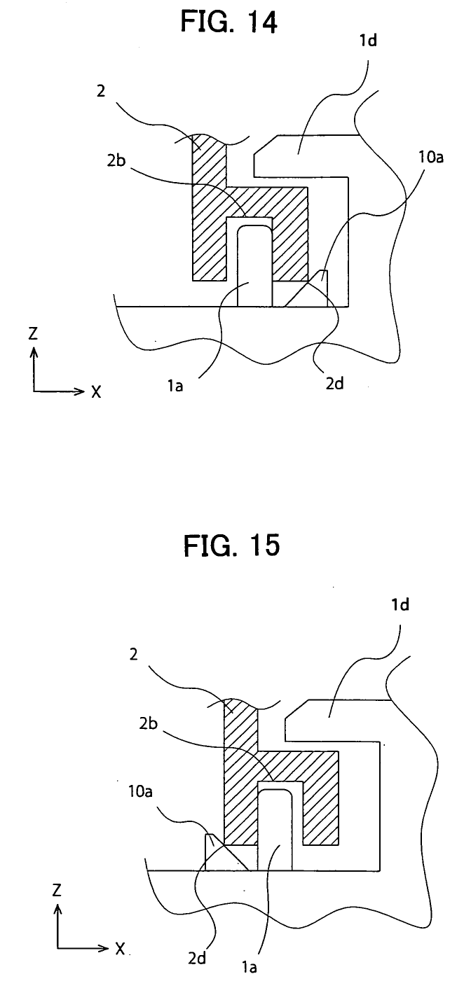

FIG. 14 is a sectional view showing a vicinity of a first horizontal guide 1a according to Embodiment 5 of the present invention, as seen from the front. In this Embodiment 5, a first contact portion 10a is provided on the +X side of and adjacent to the first horizontal guide 1a so that the first contact portion 10a is distanced from the first horizontal guide 1a. The first contact portion 10a has an inclined surface which is inclined so that the height decreases toward the −X side. Further, a ridge on the +X side of the lower end of the to-be-guided portion 2b of the tray 2 constitutes a first sliding portion 2d that contacts the first contact portion 10a. The other configuration is the same as Embodiment 1.

In this Embodiment 5, the sliding portion 2b of the tray 2 contacts the inclined surface of the first contact portion 1a adjacent to the first horizontal guide 1a to eliminate the gap between the to-be-guided portion 2b and the first horizontal guide 1a, and therefore it becomes possible to prevent the displacement of the tray 2 in the X direction, and to accomplish a stable insertion/ejection operation.

### Embodiment 6

FIG. 15 is a sectional view showing a vicinity of a first horizontal guide 1a of a disk loading apparatus according to Embodiment 6 of the present invention, as seen from the front. In this Embodiment 6, the first contact portion 10a is provided on the −X side of the first horizontal guide 1a, which is different from Embodiment 5 (FIG. 14). Further, a ridge on −X side of the lower end (an end portion of −Z side) of the to-be-guided portion 2b of the tray 2 constitutes a first sliding portion 2d contacting the first contact portion 10a. The other configuration is the same as Embodiment 5.

In this Embodiment 6, although the direction in which the to-be-guided portion 2b of the tray 2 is urged by the first horizontal guide 1a is different from that of Embodiment 5, it becomes possible to eliminate the gap in the X direction between the to-be-guided portion 2b and the first horizontal guide 1a, and to accomplish a stable insertion/ejection operation, as in Embodiment 5.

### Embodiment 7

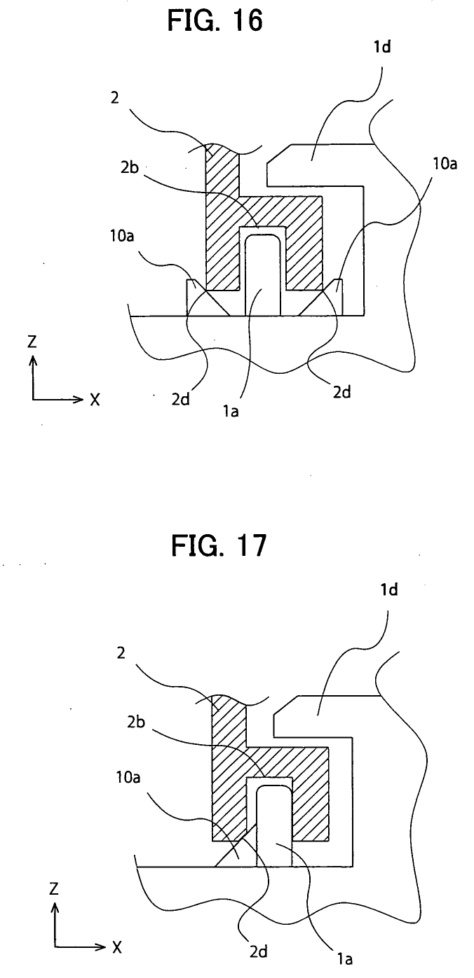

FIG. 16 is a sectional view showing a vicinity of a first horizontal guide 1a of a disk loading apparatus according to Embodiment 7 of the present invention, as seen from the front. In this Embodiment 7, configurations of Embodiment 5 (FIG. 14) and Embodiment 6 (FIG. 15) are combined with each other.

In other words, two first contact portions 10a are integrally formed on both sides of the first horizontal guide 1a in the X direction, and the first contact portions 10a have inclined surfaces which are inclined symmetrically with respect to each other. Further, the to-be-guided portion 2b of the tray 2 has two first sliding portions 2d constituted by ridges on both sides in the X direction of the lower end (an portion end of −Z side) thereof, and the first sliding portions 2d respectively contact the inclined surfaces of the first contact portions 10a. The other configuration is the same as Embodiment 5.

In this Embodiment 7, two first sliding portions 2d on both sides of the to-be-guided portion 2b of the tray 2 contact two first contact portions 10a on both sides of the first horizontal guide 1a so that the movement of the tray 2 is restricted in the X direction. As a result, it becomes possible to prevent the displacement of the tray 2 in the X direction, and to accomplish a stable insertion/ejection operation.

### Embodiment 8

FIG. 17 is a sectional view showing a vicinity of a first horizontal guide 1a of a disk loading apparatus according to Embodiment 8 of the present invention, as seen from the front. In this Embodiment 8, the first sliding portion 2d of the tray 2 having been described in Embodiment 1 (FIG. 4(A)) is chamfered. In other words, the first sliding portion 2d of the tray 2 of Embodiment 8 is constituted by an inclined surface parallel to the inclined surface of the first contact portion 10a. The other configuration is the same as Embodiment 1.

In this Embodiment 8, the first sliding portion 2d of the tray 2 and the first contact portion 10a contact each other in face-to-face contact, and therefore the abrasion of the first sliding portion 2d can be reduced even when the insertion/ejection operation of the tray 2 is repeated for a long time period. In other words, it becomes possible to maintain a stable insertion/ejection operation of the tray 2 for a long time period.

### Embodiment 9

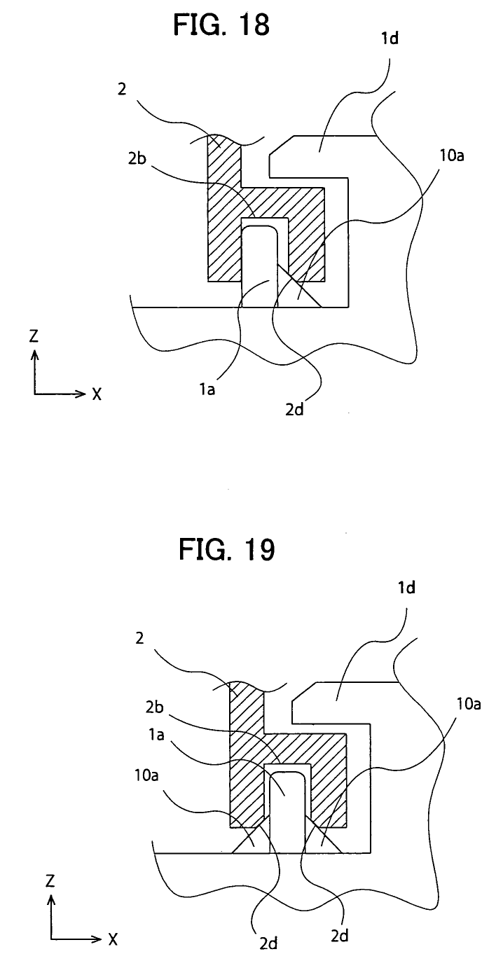

FIG. 18 is a sectional view showing a vicinity of a first horizontal guide 1a of a disk loading apparatus according to Embodiment 9 of the present invention. In this Embodiment 9, the first sliding portion 2d of the tray 2 having been described in Embodiment 3 (FIG. 12) is chamfered so as to be parallel to the inclined surface of the first contact portion 10a. The other configuration is the same as Embodiment 1.

In this Embodiment 9, the abrasion of the first sliding portion 2d can be reduced even when the insertion/ejection operation of the tray 2 is repeated for a long time period, as in Embodiment 8. In other words, it becomes possible to maintain a stable insertion/ejection operation of the tray 2 for a long time period.

### Embodiment 10

FIG. 19 is a sectional view showing a vicinity of a first horizontal guide 1a of a disk loading apparatus according to Embodiment 10 of the present invention. In this Embodiment 10, the first sliding portion 2d of the tray 2 having been described in Embodiment 4 (FIG. 13) is chamfered. In other words, two first sliding portions 2d of the tray 2 of Embodiment 10 are constituted by inclined surfaces respectively parallel to the inclined surfaces of the first contact portions 10a. The other configuration is the same as Embodiment 4.

In this Embodiment 10, two first sliding portions 2d of the tray 2 and two first contact portions 10a contact each other in face-to-face contact, and therefore the abrasion of the first sliding portions 2d can be reduced even when the insertion/ejection operation of the tray 2 is repeated for a long time period. In other words, it becomes possible to maintain a stable insertion/ejection operation of the tray 2 for a long time period.

### Embodiment 11

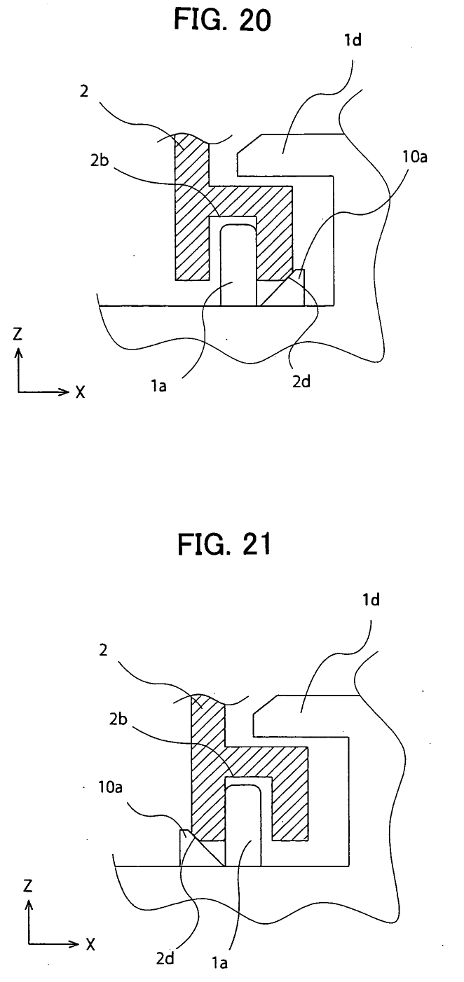

FIG. 20 is a sectional view showing a vicinity of a first horizontal guide 1a of a disk loading apparatus according to Embodiment 11 of the present invention, as seen from the front. In this Embodiment 11, the first sliding portion 2d of the tray 2 having been described in Embodiment 5 (FIG. 14) is chamfered. In other words, the first sliding portion 2d of the tray 2 of Embodiment 11 is constituted by an inclined surface parallel to the inclined surface of the first contact portion 10a. The other configuration is the same as Embodiment 5.

In this Embodiment 11, the abrasion of the first sliding portion 2d can be reduced even when the insertion/ejection operation of the tray 2 is repeated for a long time period, as in Embodiments 8 through 10. In other words, it becomes possible to maintain a stable insertion/ejection operation of the tray 2 for a long time period.

### Embodiment 12

FIG. 21 is a sectional view showing a vicinity of a first horizontal guide 1a of a disk loading apparatus according to Embodiment 12 of the present invention, as seen from the front. In this Embodiment 12, the first sliding portion 2d of the tray 2 having been described in Embodiment 6 (FIG. 15) is chamfered so as to be parallel to the inclined surface of the first contact portion 10a.

In this Embodiment 12, the abrasion of the first sliding portion 2d can be reduced even when the insertion/ejection operation of the tray 2 is repeated for a long time period, as in Embodiments 8 through 11. In other words, it becomes possible to maintain a stable insertion/ejection operation of the tray 2 for a long time period.

### Embodiment 13

FIG. 22 is a sectional view showing a vicinity of a first horizontal guide 1a of a disk loading apparatus according to Embodiment 13 of the present invention, as seen from the front. In this Embodiment 13, the sliding portions 2d of the tray 2 having been described in Embodiment 7 (FIG. 16) are chamfered. In other words, two first sliding portions 2d of the tray 2 of Embodiment 13 are constituted by inclined surfaces respectively parallel to the inclined surfaces of two first contact portions 10a. The other configuration is the same as Embodiment 7.

In this Embodiment 13, two first sliding portions 2d of the tray 2 and two first contact portions 10a contact each other in face-to-face contact, and therefore the abrasion of the first sliding portions 2d can be reduced even when the insertion/ejection operation of the tray 2 is repeated for a long time period. In other words, it becomes possible to maintain a stable insertion/ejection operation of the tray 2 for a long time period.

### Embodiment 14

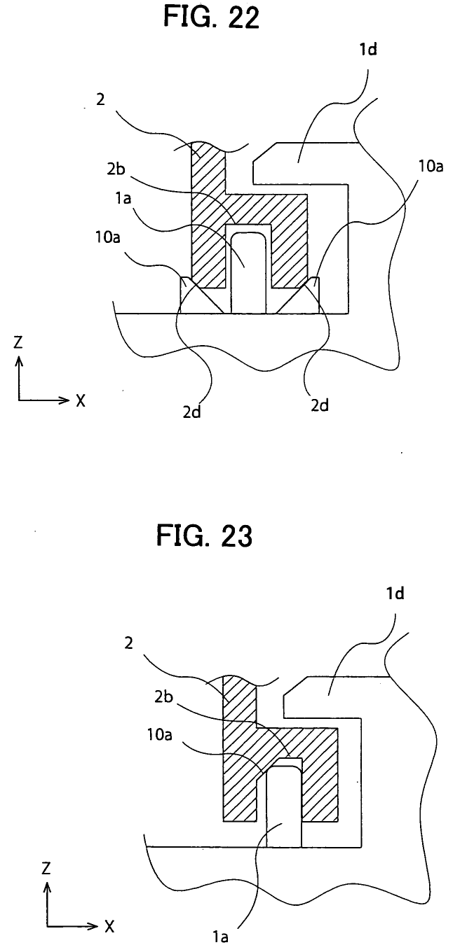

FIG. 23 is a sectional view showing a vicinity of a first horizontal guide 1a of a disk loading apparatus according to Embodiment 14 of the present invention, as seen from the front. Although the first contact portion 10a is formed on the main chassis 1 in the above described Embodiments 1 through 13, the first contact portion 10a is formed on the to-be-guided portion 2b of the tray 2 in this Embodiment 14. To be more specific, the first contact portion 10a is formed on the −X side of the groove portion constituting the to-be-guided portion 2b of the tray 2, and the first contact portion 10a has an inclined surface which is inclined so that the height decreases toward the −X direction.

In this Embodiment 14, the to-be-guided portion 2b of the tray 2 is urged in the −X direction by a force component of a reactive force applied to the first contact portion 10a by the first horizontal guide 1a, and therefore the to-be-guided portion 2b is guided so as to form no gap between the to-be-guided portion 2b and the first horizontal guide 1a. Therefore, it becomes possible to prevent the displacement of the tray 2 in the X direction, and to accomplish a stable insertion/ejection operation.

### Embodiment 15

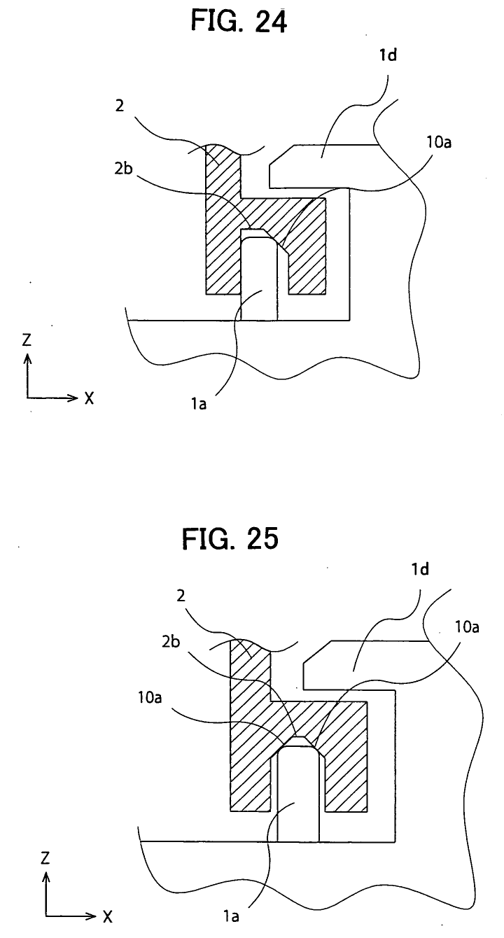

FIG. 24 is a sectional view showing a vicinity of a first horizontal guide 1a of a disk loading apparatus according to Embodiment 15 of the present invention, as seen from the front. Embodiment 15 is different from the above described Embodiment 14 (FIG. 23) in that the first contact portion 10a is provided on the +X side of the first horizontal guide 1a. Therefore, the direction in which the to-be-guided portion 2b is urged by the first horizontal guide 1a is also +X direction. Other configuration is the same as Embodiment 14.

In this Embodiment 15, although the direction in which the to-be-guided portion 2b of the tray 2 is urged by the first horizontal guide 1a at the first contact portion 10a is different from that in Embodiment 14, it becomes possible to eliminate the gap in the X direction between the to-be-guided portion 2b and the first horizontal guide 1a to thereby prevent the displacement of the tray 2 in the X direction, and to accomplish a stable insertion/ejection operation, as in Embodiment 14.

### Embodiment 16

FIG. 25 is a sectional view showing a vicinity of a first horizontal guide 1a of a disk loading apparatus according to Embodiment 16 of the present invention, as seen from the front. In this Embodiment 16, configurations of Embodiment 14 (FIG. 23) and Embodiment 15 (FIG. 24) are combined. In other words, in this Embodiment 16, two first contact portions 10a are integrally formed in the groove portion of the to-be-guided portion 2b of the tray 2 so that the first contact portions 10a contact two first sliding portions 2d which are ridges on the +X side and the −X side of the upper end (an end portion on the +Z side) of the first horizontal guide 1a, and the first contact portions 10a have inclined surfaces which are inclined symmetrically with respect to each other.

In this Embodiment 16, two first contact portions 10a contact two first sliding portions 2d on both sides of the first horizontal guide 1a so that the movement of the tray 2 is restricted in the X direction. As a result, it becomes possible to prevent the displacement of the tray 2, and to accomplish a stable insertion/ejection operation.

### Embodiment 17

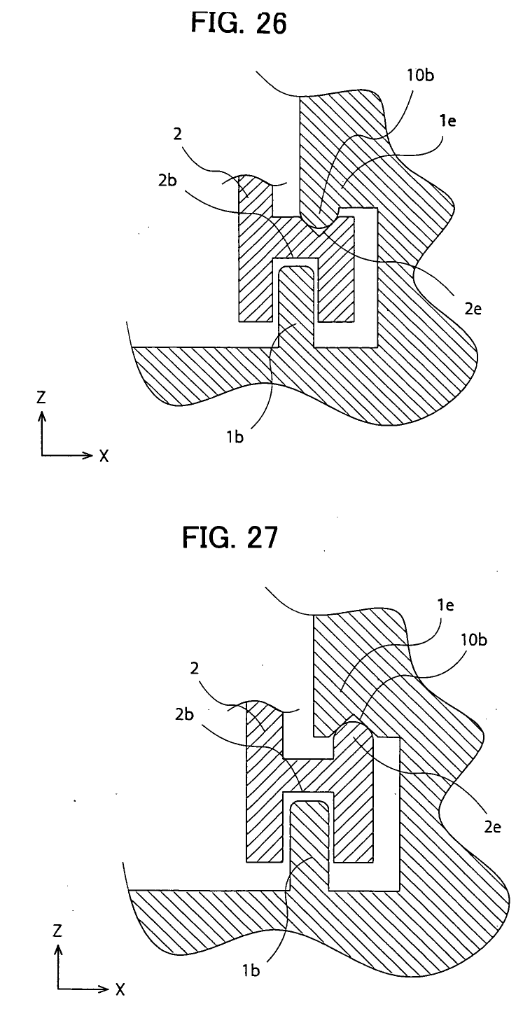

FIG. 26 is a sectional view showing a vicinity of a second vertical guide 1e of a disk loading apparatus according to Embodiment 17 of the present invention, as seen from the front. In Embodiment 17, a second contact portion 10b as a convex portion having a semi-cylindrical surface is integrally formed on a surface of the second vertical guide 1e of the main chassis 1 that faces the to-be-guided portion 2b in the above described Embodiment 2 (FIGS. 10 and 11). Further, the to-be-guided portion 2b of the tray 2 has a second sliding portion 2e as a groove portion extending in the Y direction so as to contact the semi-cylindrical surface of the second contact portion 10b. The sectional shape of the second sliding portion 2e is V-shaped and has two inclined surfaces contacting the cylindrical surface of the second contact potion 10b at two positions.

In this Embodiment 17, the to-be-guided portion 2b of the tray 2 is guided at two positions by the first horizontal guide 1a and the second horizontal guide 1b so as to form no gap in the X direction, and therefore it becomes possible to surely prevent the displacement of the tray 2 in the X direction that has conventionally occurred when the tray 2 is in the ejected position. Particularly, since the V-shaped groove of the second sliding portion 2e and the semi-cylindrical surface of the second contact portion 10b contact each other to thereby regulate the position of the to-be-guided portion 2b in the X direction, it becomes possible to further surely prevent the displacement of the tray 2 in the X direction.

### Embodiment 18

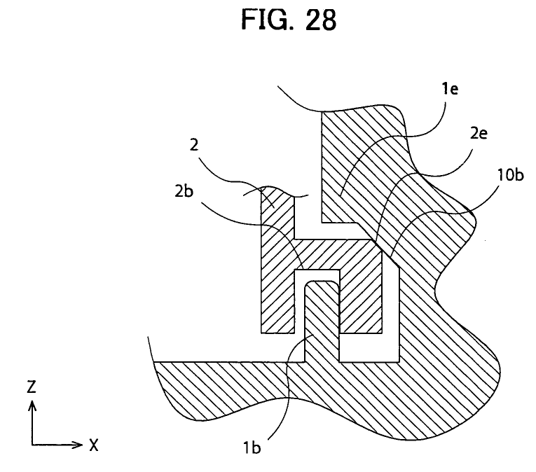

FIG. 27 is a sectional view showing a vicinity of a second vertical guide 1e of a disk loading apparatus according to Embodiment 18 of the present invention, as seen from the front. In this Embodiment 18, sectional shapes of the second contact portion 10b and the second sliding portion 2e are interchanged with each other in the above described Embodiment 17 (FIG. 26). In other words, in this Embodiment 18, the second sliding portion 2e formed on the tray 2 has a cylindrical shape and extend in the Y direction. Further, the second contact portion 10b formed on the second vertical guide 1e of the main chassis 1 is formed as a groove having, for example, a V-shaped cross section so as to contact the semi-cylindrical surface of the second sliding portion 2e.

In this Embodiment 18, the semi-cylindrical surface of the second sliding portion 2e and the V-shaped groove of the second contact portion 10b contact each other to thereby regulate the position of the to-be-guided portion 2b in the X direction, and therefore it becomes possible to further surely prevent the displacement of the tray 2 in the X direction, as in Embodiment 17.

### Embodiment 19

FIG. 28 is a sectional view showing a vicinity of a second horizontal guide 1e of a disk loading apparatus according to Embodiment 19 of the present invention, as seen from the front. In this Embodiment 19, the sliding portion 2e of the tray 2 having been described in Embodiment 2 (FIGS. 10 and 11) is chamfered. In other words, in this Embodiment 19, an inclined surface is formed on the second sliding portion 2e of the tray 2, which is parallel to the inclined surface of the second contact portion 10b.

In this Embodiment 19, the second sliding portion 2e and the second contact portion 10b contact each other in face-to-face contact, and therefore the abrasion of the second sliding portion 2e can be reduced even when the insertion/ejection operation is repeated for a long time period. In other words, it becomes possible to maintain a stable insertion/ejection operation for a long time period.

In the above described Embodiments 1 through 19, the contact portions 10a and 10b and the sliding portions 2d and 2e are provided on the right side piece Q of the main chassis 1. However, the contact portions 10a and 10b and the sliding portions 2d and 2e can be provided on the left side piece S instead of the right side piece Q.

Further, the present invention is applicable to a loading apparatus of a printer, a facsimile machine, a copier or the like that requires the replacement, replenishment or the like of sheets.

1-12. (canceled)

13. A disk loading apparatus comprising:
a tray on which a disk is placed;
a main chassis into which said tray is inserted and from which said tray is ejected;
a first horizontal guide provided on an ejection side of said tray in said main chassis;
a second horizontal guide provided on an insertion side of said tray with respect to said first horizontal guide in said main chassis;
a first vertical guide provided on said main chassis so as to face said first horizontal guide;
a second vertical guide provided on said main chassis so as to face said second horizontal guide;
a first contact portion formed integrally with or disposed adjacent to said first horizontal guide, said first contact portion having an inclined surface which is inclined with respect to a direction perpendicular to a disk surface;
a second contact portion formed integrally with or disposed adjacent to said second vertical guide, said second contact portion having an inclined surface which is inclined with respect to a direction perpendicular to said disk surface;
a to-be-guided portion provided on said tray so as to be parallel to an insertion/ejection direction, said to-be-guided portion being guided by said first and second horizontal guides;
a first sliding portion provided on said tray, said first sliding portion slidably contacting said first contact portion, and
a second sliding portion provided on said tray, said second sliding portion slidably contacting said second contact portion,
wherein said first and second sliding portions contact respective inclined surfaces of said first and said contact portions to thereby restrict a displacement of said tray in a direction perpendicular to said insertion/ejection direction in a plane parallel to said disk surface, using a weight of said tray.

14. The disk loading apparatus according to claim 13, wherein said first contact portion is formed integrally on a side of said first horizontal guide in a direction perpendicular to said insertion/ejection direction in a plane parallel to a disk surface.

15. The disk loading apparatus according to claim 13, wherein said second sliding portion is chamfered so as to be parallel to an inclined surface of said contact portion.

16. The disk loading apparatus according to claim 15, wherein said contact portion is formed on a side of said first horizontal guide in a direction perpendicular to said insertion/ejection direction in a plane parallel to a disk surface.

17. The disk loading apparatus according to claim 15, wherein a pair of said contact portions are formed on both sides of said first horizontal guide in a direction perpendicular to said insertion/ejection direction in a plane parallel to a disk surface.

18. The disk loading apparatus according to claim 15, wherein said contact portion is disposed adjacent to a side of said first horizontal guide with a space formed therebetween in a direction perpendicular to said insertion/ejection direction in a plane parallel to a disk surface.

19. The disk loading apparatus according to claim 15, wherein a pair of said contact portions are disposed adjacent to both sides of said first horizontal guide with spaces formed therebetween in a direction perpendicular to said insertion/ejection direction in a plane parallel to a disk surface.

20. The disk loading apparatus according to claim 15, wherein a second horizontal guide is disposed on an insertion side of said tray with respect to said first horizontal guide,
wherein a first vertical guide and a second vertical guide are disposed so as to face said first horizontal guide and said second horizontal guide, and
a further contact portion is formed integrally with or disposed adjacent to said second vertical guide.

21. The disk loading apparatus according to claim 13, wherein said displacement restricting mechanism includes:
a contact portion formed on a groove constituting said to-be-guided portion of said tray, and
a sliding portion formed on said guide member of said main chassis,
wherein said contact portion of said tray has an inclined surface which is inclined with respect to a direction perpendicular to a disk surface, and
wherein said inclined surface contacts said sliding portion of said guide member to thereby cause a force component of a weight of said tray, so as to restrict a displacement of said tray using said force component.

22. The disk loading apparatus according to claim 21, wherein said contact portion is formed on a side of a groove constituting said to-be-guided portion in a direction perpendicular to said insertion/ejection direction in a plane parallel to a disk surface.

23. The disk loading apparatus according to claim 21, wherein a pair of said contact portions are formed on both sides of a groove constituting said to-be-guided portion in a direction perpendicular to said insertion/ejection direction in a plane parallel to a disk surface.

24. The disk loading apparatus according to claim 14, wherein said sliding portion is chamfered so as to be parallel to an inclined surface of said contact portion.
